(19) United States
(12) Patent Application Publication
(10) Pub. No.: US 2013/0152818 A1
(43) Pub. Date: Jun. 20, 2013

(54) FUEL HEATING SYSTEM FOR A MULTI-ENGINE MACHINE

(71) Applicant: Matthew G. HOLL, East Peoria, IL (US)

(72) Inventor: Matthew G. HOLL, East Peoria, IL (US)

(21) Appl. No.: 13/326,758

(22) Filed: Dec. 15, 2011

(51) Int. Cl. B61C 5/00; F02M 31/14

(52) U.S. Cl. 105/62.1; 123/557

(57) ABSTRACT

A fuel heating system for a machine is disclosed. The fuel heating system may have a fuel tank, and a fuel supply line fluidly connected to the fuel tank, to a first engine, and to a second engine. The fuel heating system may also have a first heat exchanger fluidly connected to the first engine to transfer heat from the first engine to fuel in the fuel supply line. In addition, the fuel heating system may have a second heat exchanger fluidly connected to transfer heat from the second engine to fuel in the fuel supply line.

### TECHNICAL FIELD

The present disclosure relates generally to a fuel heating system and, more particularly, to a fuel heating system for a machine powered by more than one engine.

### BACKGROUND

Locomotives traditionally employed a single high-power internal combustion engine for driving the locomotive and supplying auxiliary demands. The duty cycle for line-haul locomotives, however, requires the engine to idle for long periods of time or the locomotive to maintain low train speeds. Operating a single large engine at low throttle settings to meet such a duty cycle reduces the engine's fuel efficiency, increases its emissions, and causes excessive engine wear and tear. Many locomotive manufacturers, therefore, employ more than one engine to power a locomotive.

Today's multi-engine locomotives typically have two diesel engines, including a large primary engine and a small auxiliary engine. Either one or both engines generate power to propel the locomotive. For example, at low throttle settings, only the small engine operates to provide power while the large engine is turned off. At intermediate throttle settings, only the large engine operates to provide power while the small engine is turned off. And, at the highest throttle setting, both engines operate to provide power to the locomotive.

A multi-engine line-haul locomotive must operate in a variety of environments, including in cold weather with ambient temperatures dipping below the freezing point of water. In such cold weather conditions, the temperature of fuel supplied to the engines can fall below a cloud point of the fuel, causing waxy compounds to precipitate out of the fuel and plug fuel filter elements or other fuel system components. In addition, at low temperatures, fuel becomes more viscous thereby making it harder for fuel to be pumped from a tank to the engines. To prevent damage to engine components caused by precipitation and to help ensure that the fuel pump can optimally deliver fuel, fuel systems in today's multi-engine locomotives should provide a ready supply of heated fuel to both the large and the small engines.

One example of a fuel heating system for diesel engines is described in U.S. Pat. No. 4,944,343, to Müller that issued on Jul. 31, 1990 (“the '343 patent”). In particular, the '343 patent discloses an apparatus for heating a viscous fuel supplied to a diesel engine. The apparatus includes a heat exchanger. Warm coolant from the engine is circulated through the heat exchanger to heat fuel circulated through the same heat exchanger. The '343 patent also discloses that to start an inoperative engine in low temperature conditions, an electrical heater disposed on the fuel filter is used to heat fuel and facilitate engine startup. The electrical heater disclosed in the '343 patent heats the fuel locally to prevent damage to the fuel filter from wax precipitation at low ambient temperatures.

Although the '343 patent discloses a method of heating fuel using engine coolant, the disclosed method can be used only when the engine is operational and heated coolant is available. Moreover, the electrical heater requires a separate source of power when the engine is off. The method disclosed in the '343 patent may also introduce a delay in engine startup because of the time required to heat the fuel using the electrical heater. In addition, because the electrical heater disclosed in the '343 patent only heats fuel locally in the fuel filter, the fuel pump may still experience excessive load in attempting to pump cold viscous fuel before the engine starts and provides warm engine coolant to heat the fuel.

The fuel heating system of the present disclosure solves one or more of the problems set forth above and/or other problems in the art.

### SUMMARY

In one aspect, the present disclosure is directed to a fuel heating system for a machine. The fuel heating system may include a fuel tank and a fuel supply line fluidly connected to the fuel tank, to a first engine, and to a second engine. The fuel heating system may also include a first heat exchanger fluidly connected to transfer heat from the first engine to fuel in the fuel supply line. In addition, the fuel heating system may include a second heat exchanger fluidly connected to transfer heat from the second engine to fuel in the fuel supply line.

In another aspect, the present disclosure is directed to a method of heating fuel. The method may include circulating coolant from a first engine through a first heat exchanger and circulating coolant from a second engine through a second heat exchanger. The method may further include selectively directing fuel through the first and second heat exchangers to at least one of the first and second engines.

### BRIEF DESCRIPTION OF THE DRAWINGS

FIG. 1 is a pictorial illustration of an exemplary disclosed machine; and

FIG. 2 is a pictorial illustration of an exemplary schematic of a fuel heating system that may be used in conjunction with the machine of FIG. 1.

### DETAILED DESCRIPTION

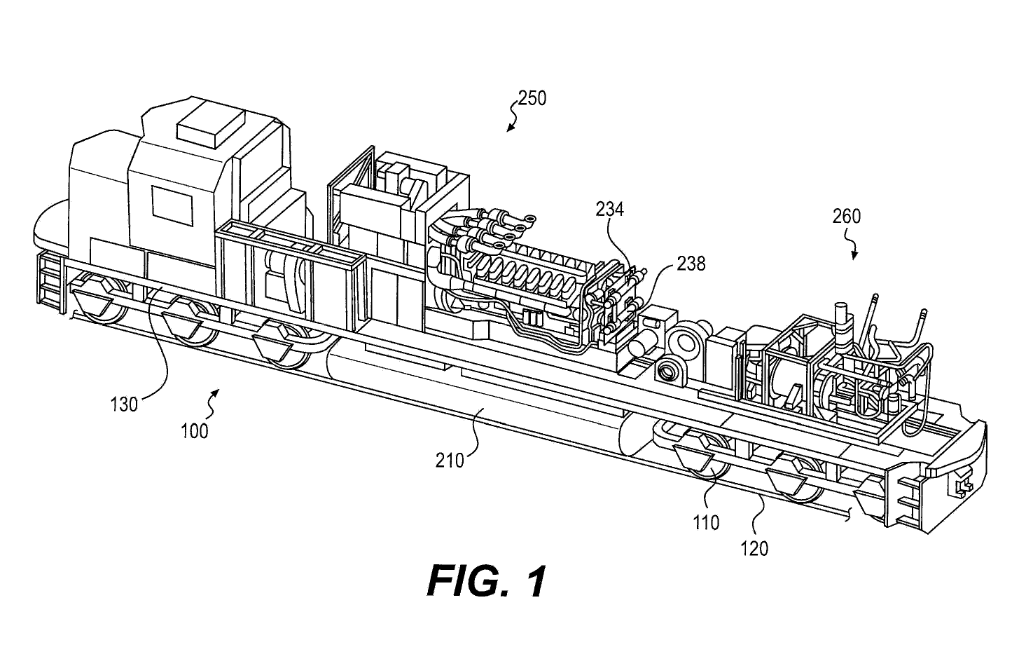

FIG. 1 illustrates an exemplary embodiment of a machine 100. Machine 100 may be a mobile machine that performs some type of operation associated with an industry such as the railroad industry, or another industry known in the art. For example, machine 100 may be a locomotive designed to pull rolling stock. Machine 100 may have a plurality of wheels 110 configured to engage a track 120, a base platform 130 supported by wheels 110, and first and second engines 250 and 260 mounted to base platform 130 and configured to drive wheels 110. Any number of additional engines may be included within machine 100 and operated to produce power that may be transferred to one or more traction motors (not shown) used to drive wheels 110. A fuel tank 210 may be mounted to base platform 130. The fuel tank 210 may supply fuel to both first and second engines 250 and 260. In the exemplary embodiment shown in FIG. 1, first engine 250 and second engine 260 may be lengthwise aligned on base platform 130 along a travel direction of machine 100.

In one exemplary embodiment of machine 100, first engine 250 may generate more power than second engine 260. Second engine 260 may be used to provide power to the machine 100 at low throttle settings, for example, when machine 100 is pulling a relatively smaller load or when machine 100 is idling. In this situation, first engine 250 may be turned off. At intermediate throttle settings, only first engine 250 may operate to provide power to machine 100 while second engine 260 may be turned off. In contrast, at the highest throttle setting, both first and second engines 250 and 260 may operate to provide power to machine 100.

First engine 250 may be fluidly connected to a first heat exchanger 234 to allow coolant from first engine 250 to circulate through heat exchanger 234. Second engine 260 may be fluidly connected to a heat exchanger 238 to allow coolant from second engine 260 to circulate through heat exchanger 238. Fuel from fuel tank 210 may be heated as it passes through heat exchangers 234 and 238 before being supplied to first and second engines 250 and 260. In the exemplary embodiment shown in FIG. 1, heat exchanger 234 may supply heat to the fuel when first engine 250 is operational and second engine 260 is turned off or when both first and second engines 250 and 260 are operational. Similarly, in the exemplary embodiment shown in FIG. 1, heat exchanger 238 may supply heat to the fuel when second engine 260 is operational and first engine 250 is turned off or when both first and second engines 250 and 260 are operational.

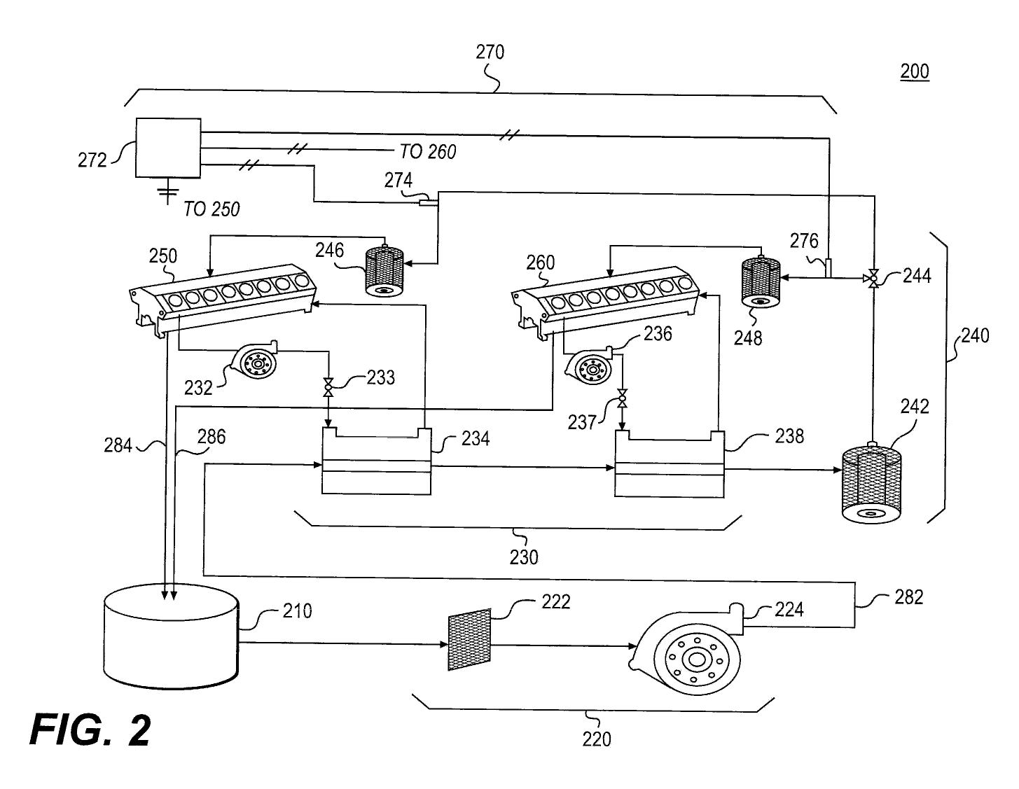

FIG. 2 illustrates a schematic diagram of a fuel heating system 200 that may be used in conjunction with machine 100 shown in FIG. 1. Fuel heating system 200 may include components that cooperate to deliver heated fuel to first and second engines 250 and 260. Specifically, fuel heating system 200 may include fuel tank 210, a pumping arrangement 220, a fuel heating arrangement 230, a fuel delivery arrangement 240, and an automatic engine start arrangement 270. Fuel heating system 200 may also include a fuel supply line 282 fluidly connecting fuel tank 210 with fuel pumping arrangement 220, fuel heating arrangement 230, fuel delivery arrangement 240, and first and second engines 250 and 260. Further, fuel heating system 200 may have fuel return lines 284 and 286 to return excess fuel not used by first and second engines 250 and 260, respectively, to fuel tank 210.

Fuel tank 210 may be configured to store a supply of fuel. The fuel may be any type of fuel commonly used in the operation of an internal combustion engine such as, for example, gasoline or diesel fuel. In one embodiment, fuel tank 210 may carry sufficient fuel for both first and second engines 250 and 260. In another embodiment, there may be more than one fuel tank 210 for supplying fuel to first and second engines 250 and 260. In one exemplary embodiment, fuel tank 210 may carry more than about 5000 gallons of fuel.

Fuel pumping arrangement 220 may include a strainer 222 to filter the fuel and a fuel pump 224 to draw fuel from fuel tank 210 through strainer 222 and pressurize the fuel. Strainer 222 may be disposed between fuel tank 210 and fuel pump 224 to trap large particulate debris and inhibit debris from entering and damaging fuel pump 224. Fuel pump 224 may pressurize fuel from fuel tank 210 and direct the fuel through fuel supply line 282 to first and second engines 250 and 260. Fuel pump 224 may be, for example, a fixed capacity, variable displacement pump. One skilled in the art will recognize, however, that fuel pump 224 may be any other type of pump, such as, for example, a variable capacity pump. In one exemplary embodiment, pump 224 may be a fuel lift pump capable of delivering a fuel flow rate of at least about 25 liters per minute (LPM). Fuel pump 224 may be powered by batteries (not shown) in machine 100. The batteries used for powering fuel pump 224 may be charged using power generated by either or both of first and second engines 250 and 260. Although only one fuel pump 224 is shown in FIG. 2, one skilled in the art would recognize that more than one fuel pump 224 may be included in fuel heating system 200.

Fuel heating arrangement 230 may include heat exchangers 234 and 238 for heating fuel, one or more coolant pumps 232 and 236 for directing coolant from first and second engines 250 and 260, respectively, to heat exchangers 234 and 238, and one or more thermostatic valves 233 and 237 to control the flow rate of coolant through heat exchangers 234 and 238.

Heat exchangers 234 and 238 may be liquid-to-liquid type heat exchangers. That is, a flow of coolant received from either first engine 250 or second engine 260 may be directed through channels of heat exchanger 234 or 238 such that heat from the coolant is transferred to fuel from supply line 282 as the fuel passes through heat exchangers 234 and 238. In this manner, fuel in fuel supply line 282 may be heated to a desired temperature.

Heat exchanger 234 may be fluidly connected to first engine 250 to receive coolant from first engine 250. Further, heat exchanger 234 may be configured to transfer heat from coolant received from first engine 250 to fuel in fuel supply line 282. Heat exchanger 238 may be fluidly connected to second engine 260 to receive coolant from second engine 260. Heat exchanger 238 may also be configured to transfer heat from the coolant received from second engine 260 to fuel in fuel supply line 282. The coolant used by first and second engines 250 and 260 may include water, glycol, a water/glycol mixture, or any other heat transferring fluid.

In one exemplary embodiment, each of heat exchangers 234 and 238 may be fluidly connected to one of first and second engines 250 and 260. In another exemplary embodiment, each of heat exchangers 234 and 238 may be fluidly connected to both first and second engines 250 and 260 such that coolant from each of first and second engines 250 and 260 may be circulated through separate channels in each of heat exchangers 234 and 238. In yet another exemplary embodiment, coolant from first and second engines 250 and 260 may be mixed before being circulated through each of heat exchangers 234 and 238.

Heat exchangers 234 and 238 may be arranged in many different ways to heat fuel in fuel supply line 282. In one exemplary embodiment, heat exchangers 234 and 238 may be disposed in series relative to fuel supply line 282, with heat exchanger 234 being located upstream of heat exchanger 238. One skilled in the art will recognize, however, that the configuration and/or order in which heat exchangers 234 and 238 are arranged in fuel heating system 200 is not limiting and heat exchangers 234 and 238 may be arranged in any manner to heat fuel in fuel supply line 282. Further, one skilled in the art will recognize that there may be one or more of heat exchangers 234 and 238 in fuel heating system 200.

Coolant pumps 232 and 236 may direct the flows of coolant from engines 250 and 260 through heat exchangers 234 and 238, respectively. For example, coolant pump 232 may pressurize coolant received from first engine 250 and direct the pressurized coolant through heat exchanger 234. Similarly, coolant pump 236 may pressurize coolant received from second engine 260 and direct the pressurized coolant through heat exchanger 238. Coolant pumps 232 and 236 may include an input device (not shown) such as a belt driven pulley, a hydraulically driven motor, or an electrically powered motor that is mounted to or otherwise driven by one of engines 250 or 260, and impeller blades (not shown) fixedly or adjustably connected thereto. Coolant pumps 232 and 236 may be, for example, fixed capacity, variable displacement pumps. One skilled in the art will recognize, however, that coolant pumps 232 and 236 may be other types of pumps, such as, for example, variable capacity pumps.

Thermostatic valves 233 and 237 may control the flow rate of coolant through heat exchangers 234 and 238, respectively, to thereby regulate an amount of heat transferred to the fuel also passing through heat exchangers 234 and 238. For example, thermostatic valve 233 may open and allow coolant to flow through heat exchanger 234 when the temperature of fuel entering heat exchanger 234 falls below a low-temperature threshold. Further, thermostatic valve 233 may close and prevent flow of coolant through heat exchanger 234 when the temperature of fuel entering the heat exchanger 234 rises above a high-temperature threshold. When the temperature of fuel entering heat exchanger 234 lies between the low-temperature and high-temperature thresholds, thermostatic valve 233 may open partially to allow some amount of coolant to flow through heat exchanger 234. Thermostatic valve 237 may control the flow of coolant through heat exchanger 238 in a similar manner.

Fuel delivery arrangement 240 may include a primary fuel filter 242 to filter the fuel in fuel supply line 282, a valve 244 to control fuel supply to engines 250 and 260, and secondary fuel filters 246 and 248 disposed before each of first and second engines 250 and 260, respectively. Primary fuel filter 242 may filter particles of size about 5 microns or larger and may serve to screen out rust, dirt, or other particles from the fuel. These particles may enter fuel heating system 200, for example, when rust or paint chips are knocked into a fuel inlet during fueling. By removing foreign material from the fuel, primary fuel filter 242 may serve to reduce abrasive wear by the particles on engine components such as fuel injectors (not shown). Primary fuel filter 242 may also allow first and second engines 250 and 260 to operate more efficiently, as uncontaminated fuel may burn more efficiently than contaminated fuel.

Valve 244 may supply fuel to first and second engines 250 and 260 depending on whether one or both of first and second engines 250 and 260 are operational. For example, when only first engine 250 is operational and second engine 260 is off, valve 244 may supply fuel to first engine 250 and block the fuel supply to second engine 260. Conversely, for example, when first engine 250 is off and only second engine 260 is operational, valve 244 may supply fuel to second engine 260 and block the fuel supply to first engine 250. Further, when both first and second engines 250 and 260 are operational, valve 244 may supply fuel to both first and second engines 250 and 260.

Secondary fuel filters 246 and 248 may be disposed to filter the fuel before it enters first and second engines 250 and 260, respectively. Each of fuel filters 246 and 248 may filter particles of size about 5 microns or smaller and may be polishing filters designed to further remove debris and contaminants from the fuel before the fuel enters first and second engines 250 and 260. In one embodiment, secondary fuel filters 246 and 248 may have a dirt capacity about an order of magnitude lower than the dirt capacity of primary fuel filter 242. Primary fuel filter 242, together with secondary fuel filters 246 and 248, may allow fuel to be filtered in a two-step process for each of first and second engines 250 and 260, respectively.

First engine 250 may be any type of engine such as, for example, a diesel engine, a gasoline, or a gaseous fuel-powered engine. First engine 250 may include an engine block which may at least partially define a plurality of cylinders (not shown). The plurality of cylinders in engine 250 may be disposed in an “in-line” configuration, a “V” configuration, or in any other suitable configuration. Similarly, second engine 260 may be any type of engine such as, for example, a diesel engine, a gasoline, or a gaseous fuel-powered engine. Second engine 260 may include an engine block which may at least partially define a plurality of cylinders (not shown). The plurality of cylinders in engine 260 may be disposed in an “in-line” configuration, a “V” configuration, or in any other suitable configuration.

An automatic engine start arrangement 270 may be used for automatically starting an inoperative engine (e.g. first engine 250 or second engine 260) to maintain fuel at a desired temperature. Automatic engine start arrangement 270 may include a controller 272 to initiate automatic startup of first and second engines 250 and 260 in response to signals from one or more temperature sensors 274 and 276 that monitor the fuel temperature entering secondary fuel filters 246 and 248, respectively. By automatically starting up first and second engines 250 and 260, controller 272 may help ensure that coolant from first and second engines 250 and 260 is available to raise the temperature of fuel in fuel supply line 282 above the threshold temperature. In one embodiment the threshold temperature may be about the cloud point of the fuel below which wax compounds may precipitate out of the fuel. In another embodiment the threshold temperature may be about 32° F.

Controller 272 may embody a single or multiple microprocessors, digital signal processors (DSPs), etc. that include means for controlling an operation of first and second engines 250 and 260. Numerous commercially available microprocessors can be configured to perform the functions of controller 272. It should be appreciated that controller 272 could readily embody a microprocessor separate from that controlling other machine-related functions, or that controller 272 could be integral with a machine microprocessor and be capable of controlling numerous machine functions and modes of operation. If separate from the general machine microprocessor, controller 272 may communicate with the general machine microprocessor via datalinks or other methods. Various other known circuits may be associated with controller 272, including power supply circuitry, signal-conditioning circuitry, actuator driver circuitry (i.e., circuitry powering solenoids, motors, or piezo actuators), and communication circuitry.

Controller 272 may also be configured to control operation of valve 244. For example, controller 272 may cause valve 244 to move from a fully open first position at which only first engine 250 receives a full supply of fuel, to a fully open second position at which only second engine 260 receives a full supply of fuel, to a fully open third position at which both first and second engines 250 and 260 receive a full supply of fuel. It is also contemplated that controller 272 may cause valve 244 to move to a fully closed position at which fuel supply to first and second engines 250 and 260 is inhibited. In one exemplary embodiment, controller 272 may direct valve 244 to supply a minimum of about 21 LPM of fuel to first engine 250 and a minimum of about 4.5 LPM of fuel to second engine 260 when first and second engines 250 and 260 are operational.

Fuel return line 284 may be fluidly connected to first engine 250 to return any excess fuel not consumed by first engine 250 to fuel tank 210. Similarly, fuel return line 286 may be fluidly connected to second engine 260 to return any excess fuel not consumed by second engine 260 to fuel tank 210. In one exemplary embodiment, fuel return lines 284 and 286 may merge into a single fuel return line (not shown) that returns excess fuel from both first and second engines 250 and 260, respectively, to fuel tank 210.

### INDUSTRIAL APPLICABILITY

The disclosed fuel heating system may be used in any machine or power system application where it is beneficial to heat fuel before supplying it to an internal combustion engine. The disclosed fuel heating system may find particular applicability with mobile machines such as locomotives that can be exposed to extreme environmental conditions including below-freezing ambient temperatures. The disclosed fuel heating system may provide an improved method for heating fuel to help ensure that the fuel temperature exceeds the cloud point for the fuel regardless of whether one or more engines of the locomotive are operating at any given time. Operation of fuel heating system 200 will now be described.

During operation of machine 100, one or more of first and second engines 250 and 260 may be operational depending on the power output required to propel machine 100 at a desired speed. In the disclosed fuel heating system 200, fuel pump 224 may pressurize fuel from fuel tank 210 and direct fuel through fuel heating arrangement 230 to first and second engines 250 and 260. When both first and second engines 250 and 260 are operational, thermostatic valve 233 may allow coolant from first engine 250 to circulate coolant through heat exchanger 234 and heat fuel in fuel supply line 282 to a first temperature. In addition, thermostatic valve 237 may allow coolant from second engine 260 to circulate coolant through heat exchanger 238 to heat fuel flowing in fuel supply line 282 to a second temperature. In one embodiment the first temperature may be a temperature between about 70° F. and 85° F. and the second temperature may be about 85° F. Further, when both first and second engines 250 and 260 are operational, controller 272 may direct valve 244 to supply fuel to both first and second engines 250 and 260.

When only one of first and second engines 250 and 260 is operational, fuel heating system 200 may heat fuel by circulating coolant from the operational engine in a heat exchanger connected to the operational engine. For example, if first engine 250 is operational and second engine 260 is turned off, thermostatic valve 237 may turn off coolant flow through heat exchanger 238 and fuel may flow through heat exchanger 238 without being substantially heated. At the same time, because first engine 250 is operational, thermostatic valve 233 may permit coolant from first engine 250 to circulate through heat exchanger 234 and heat fuel in fuel supply line 282 as it flows through heat exchanger 234. Thermostatic valve 233 may control the amount of coolant from first engine 250 that may flow through heat exchanger 234 to help ensure that fuel in the fuel supply line 282 may be heated to a temperature above the fuel's cloud point before entering fuel filter 242. In one embodiment fuel heating system 200 may heat fuel to a temperature of about 85° F. before it enters fuel filter 242. Further, when only first engine 250 is operational, controller 272 may direct valve 244 to supply fuel to first engine 250 and block fuel supply to inoperative second engine 260. If the throttle settings on the machine 100 are changed, or if some other condition arises requiring second engine 260 to start up, controller 272 may direct valve 244 to supply already heated fuel to second engine 260 to facilitate its start up. Thus, fuel heating system 200 may provide heated fuel to previously inoperative second engine 260 without the need for additional fuel heaters or power sources for such heaters.

As another example, when only second engine 260 is operational and first engine 250 is turned off, thermostatic valve 237 may permit coolant from engine 260 to circulate through heat exchanger 238 and fuel in fuel supply line 282 may be heated as the fuel flows through heat exchanger 238. However, because first engine 250 has been turned off, thermostatic valve 233 may block coolant flow through heat exchanger 234 and fuel may flow through heat exchanger 234 without being substantially heated. Thermostatic valve 237 may control the amount of coolant from second engine 260 that may flow through heat exchanger 238 to ensure that fuel in fuel supply line 282 may be heated to a temperature above the fuel's cloud point before entering primary fuel filter 242. In one embodiment fuel heating system 200 may heat fuel to a temperature of about 85° F. before it enters fuel filter 242. Further, when only second engine 260 is operational, controller 272 may direct valve 244 to supply fuel to second engine 260 and block fuel supply to inoperative first engine 250. If the throttle settings on the machine 100 are changed, or if some other condition arises requiring first engine 250 to start up, controller 272 may direct valve 244 to supply heated fuel to first engine 250 to facilitate its start up. Thus, fuel heating system 200 may provide a ready supply of heated fuel to previously inoperative engine 250 without a significant time lag. Moreover fuel heating system 200 may provide heated fuel to either or both first and second engines 250 and 260 depending on which of first and second engines 250 and 260 is operational.

When both engines 250 and 260 have been turned off, fuel pump 224 may continue to pump fuel through fuel supply line 282 and fuel return lines 284 and 286. Further, if the temperature of the fuel entering first and second engines 250 and 260 drops below another threshold temperature, controller 272 may cause fuel heating system 200 to responsively start one of first and second engines 250 and 260 to thereby heat the fuel. In one embodiment the threshold temperature may be about 32° F.

It will be apparent to those skilled in the art that various modifications and variations can be made to the disclosed fuel heating system without departing from the scope of the disclosure. Other embodiments of the fuel heating system will be apparent to those skilled in the art from consideration of the specification and practice of the fuel heating system disclosed herein. It is intended that the specification and examples be considered as exemplary only, with a true scope of the disclosure being indicated by the following claims and their equivalents.

What is claimed is:

1. A fuel heating system, comprising:
a fuel tank;
a fuel supply line fluidly connected to the fuel tank, to a first engine, and to a second engine;
a first heat exchanger fluidly connected to transfer heat from the first engine to fuel in the fuel supply line; and
a second heat exchanger fluidly connected to transfer heat from the second engine to fuel in the fuel supply line.

2. The fuel heating system of claim 1, wherein the first heat exchanger and the second heat exchanger are arranged in series relative to the fuel supply line.

3. The fuel heating system of claim 1, wherein the first heat exchanger heats the fuel in the fuel supply line when the first engine is operative and the second engine is inoperative or when both are operative, and the second heat exchanger heats the fuel in the fuel supply line when the first engine is inoperative and the second engine is operative or when both are operative.

4. The fuel heating system of claim 1, further including:
a first thermostatic valve configured to control a flow rate of coolant from the first engine through the first heat exchanger such that the fuel in the fuel supply line is heated to a first temperature in the first heat exchanger; and
a second thermostatic valve configured to control the flow rate of coolant from the second engine through the second heat exchanger such that the fuel in the fuel supply line is heated to a second temperature in the second heat exchanger.

5. The fuel heating system of claim 1, further including a controller configured to start at least one of the first and second engines when both the first engine and the second engine are inoperative and a temperature of fuel in the fuel supply line is below a threshold temperature.

6. The fuel heating system of claim 5, wherein the threshold temperature is a temperature below which wax compounds precipitate out of the fuel.

7. The fuel heating system of claim 6, wherein the threshold temperature is about 32° F.

8. The fuel heating system of claim 2, wherein the first engine is configured to generate more power than the second engine.

9. The fuel heating system of claim 4, wherein fuel is heated to a temperature of about 85° F. within the first and second heat exchangers.

10. The fuel heating system of claim 1, wherein the fuel supply line supplies fuel to the first engine after passing through the first heat exchanger and the second heat exchanger.

11. A method of heating fuel, comprising:
circulating coolant from a first engine through a first heat exchanger;
circulating coolant from a second engine through a second heat exchanger;
selectively directing fuel through the first and second heat exchangers to at least one of the first and second engines.

12. The method of claim 11, wherein the first and second heat exchangers are arranged in series.

13. The method of claim 11, further including:
controlling a flow rate of coolant from the first engine through the first heat exchanger such that the fuel is heated to a first temperature; and
controlling a flow rate of coolant from the second engine through the second heat exchanger such that the fuel is heated to a second higher temperature.

14. The method of claim 11, further including:
detecting a temperature of fuel in the fuel supply line directed through the first heat exchanger and the second heat exchanger; and
starting at least one of the first and second engines in response to a temperature of fuel in the fuel supply line being below a threshold temperature.

15. The method of claim 11, wherein fuel directed to the first engine and the second engine is heated in the first heat exchanger and the second heat exchanger to a temperature above precipitation temperature of the fuel.

16. The method of claim 15, wherein the fuel is heated to a temperature of above about 32° F.

17. A locomotive comprising:
a platform;
a plurality of wheels configured to support the platform;
a fuel tank mounted to the platform;
a first engine mounted to the platform;
a second engine mounted on the platform;
a fuel supply line fluidly connecting the fuel tank to the first engine and to the second engine;
a fuel filter in the fuel supply line upstream of the first and second engines;
a fuel valve configured to direct a desired amount of fuel to the first engine and the second engine;
a first heat exchanger fluidly connected to transfer heat from the first engine to fuel in the fuel supply line;
a second heat exchanger fluidly connected to transfer heat from the second engine to fuel in the fuel supply line;
a first thermostatic valve to control a flow rate of coolant from the first engine through the first heat exchanger; and
a second thermostatic valve to control a flow rate of coolant from the second engine through the second heat exchanger.

18. The locomotive of claim 17, wherein the first heat exchanger and the second heat exchanger are arranged in series.

19. The locomotive of claim 17, wherein the first engine is configured to generate more power than the second engine.

20. The locomotive of claim 17, further including a controller configured to start at least one of the first and second engines when both the first engine and the second engine are inoperative and a temperature of fuel in the fuel supply line is below a threshold temperature.
